(19) United States
(12) Patent Application Publication
(10) Pub. No.: US 2014/0372207 A1
(43) Pub. Date: Dec. 18, 2014

(54) PROFIT INDEX VALUE GENERATION SYSTEM AND PROFIT INDEX VALUE GENERATION METHOD

(71) Applicant: YAHOO JAPAN CORPORATION, Tokyo (JP)

(72) Inventors: Toru HOTTA, Tokyo (JP); Yusuke TANAKA, Tokyo (JP); Yukihiro TAGAMI, Tokyo (JP)

(21) Appl. No.: 14/303,002

(22) Filed: Jun. 12, 2014

(30) Foreign Application Priority Data
Jun. 18, 2013 (JP) 2013-127724

(51) Int. Cl. G06Q 30/02

(52) U.S. Cl. CPC G06Q 30/0247
USPC 705/14.46

(57) ABSTRACT

A profit index value generation system includes a profit index value calculating unit. The profit index value calculating unit calculates a profit index value related to a link destination web page in accordance with (i) a selection probability value that indicates a probability of selection of link information, the link information being posted on a link source web page displayed on a display screen of a terminal and being linked to the link destination web page on which advertisement information is posted, and (ii) an expected profit value that indicates an amount of profit which is expected to be generated as a result of the advertisement information being displayed on the display screen together with the link destination web page.

### CROSS-REFERENCE TO RELATED APPLICATIONS

The present invention contains subject matter related to Japanese Patent Application No. 2013-127724 filed in the Japan Patent Office on Jun. 18, 2013, the entire contents of which are incorporated herein by reference.

### BACKGROUND OF THE INVENTION

1. Field of the Invention

The present invention relates to a profit index value generation system and a profit index value generation method.

2. Description of the Related Art

A web page shows recommendation information such as information for introducing another web page (link information), for example, “people who read this news article also read the following news article”. Link information linking to a web page that is to be preferentially posted is determined on the basis of a history that indicates the frequency with which link information linking to each web page has been selected (see, for example, Japanese Unexamined Patent Application Publication No. 2011-34399). For example, in a case where a history is recognized in which link information linking to a web page (B) has been selected with high frequency when the link information is posted on a web page (A), the link information linking to the web page (B) is preferentially posted on the web page (A).

Advertisement information may be posted on a web page, and a system for generating profit in association with the advertisement information may be operated. Even if link information linking to the web page (B) is selected with high frequency on the web page (A), the profit generated from advertisement information posted on the web page (B) as a result of transition from the web page (A) to the web page (B) may be small. Meanwhile, even if link information linking to a web page (C) is selected with low frequency on the web page (A), the profit generated from advertisement information posted on the web page (C) as a result of transition from the web page (A) to the web page (C) may be large. In such a case, if the link information linking to the web page (B) is preferentially posted on the web page (A) on the basis of the frequency with which the link information was selected, the link information linking to the web page (C) for which profit may be generated from advertisement information may be hindered from being posted. Accordingly, in view of a possibility that link information linking to a web page for which profit may be generated from advertisement information is hindered from being posted as a result of link information linking to a web page that was selected with high frequency being preferentially posted, and profit efficiency is not increased, the applicant has developed a new method for appropriately selecting link information linking to a web page in view of the profit to be obtained from advertisement information posted on a link destination web page that is introduced by link information.

### SUMMARY OF THE INVENTION

An embodiment of the present invention has been made in view of the above-described circumstances, and provides a profit index value generation system and a profit index value generation method that are configured to appropriately select a link destination web page introduced by link information so as to increase the profit to be obtained from advertisement information on the link destination web page as a result of selection of the link information.

According to an embodiment of the present invention, there is provided a profit index value generation system including a profit index value calculating unit. The profit index value calculating unit calculates a profit index value related to a link destination web page in accordance with (i) a selection probability value that indicates a probability of selection of link information, the link information being posted on a link source web page displayed on a display screen of a terminal and being linked to the link destination web page on which advertisement information is posted, and (ii) an expected profit value that indicates an amount of profit which is expected to be generated as a result of the advertisement information being displayed on the display screen together with the link destination web page.

According to another embodiment of the present invention, there is provided a profit index value generation method. The method includes calculating a profit index value related to a link destination web page in accordance with (i) a selection probability value that indicates a probability of selection of link information, the link information being posted on a link source web page displayed on a display screen of a terminal and being linked to the link destination web page on which advertisement information is posted, and (ii) an expected profit value that indicates an amount of profit which is expected to be generated as a result of the advertisement information being displayed on the display screen together with the link destination web page.

Further features of the embodiments of the present invention will become apparent from the following description of the embodiments given below with reference to the attached drawings.

According to the embodiments of the present invention, a link destination web page introduced by link information may be appropriately selected to increase the amount of profit obtained from advertisement information posted on the link destination web page as a result of selection of the link information.

### BRIEF DESCRIPTION OF THE DRAWINGS

FIG. 1 is a diagram illustrating an overall configuration of a profit index value generation system according to a first embodiment;

FIG. 2 is a block diagram illustrating a schematic inner configuration of a profit index value generation apparatus according to the first embodiment;

FIG. 3 illustrates an example of a link source web page displayed on a display screen of a terminal;

FIG. 4 is a diagram illustrating a schematic data structure of a first database;

FIG. 5 illustrates an example of a link destination web page displayed on the display screen of the terminal;

FIG. 6 is a diagram illustrating a schematic data structure of a second database;

FIG. 7 is a diagram illustrating an overall configuration of a profit index value generation system according to a second embodiment;

FIG. 8 is a block diagram illustrating a schematic inner configuration of a profit index value generation apparatus according to the second embodiment;

FIG. 9 is a diagram illustrating an overall configuration of a profit index value generation system according to a third embodiment; and

FIG. 10 is a block diagram illustrating a schematic inner configuration of a profit index value generation apparatus according to the third embodiment.

### DETAILED DESCRIPTION OF THE EMBODIMENTS

### First Embodiment

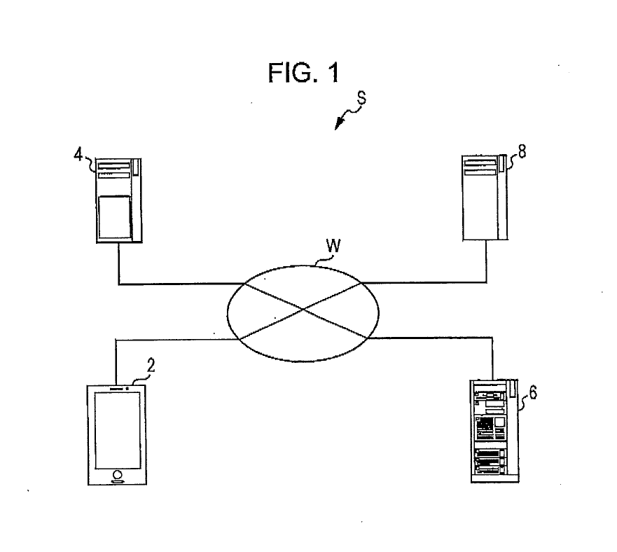

Hereinafter, a first embodiment will be described with reference to the attached drawings. FIG. 1 is a diagram illustrating an overall configuration of a profit index value generation system S according to the first embodiment of the present invention. The profit index value generation system S includes a terminal 2, a content server 4, a profit index value generation apparatus 6, and an advertiser server 8, which are connected to one another via the Internet W.

Terminal 2

The terminal 2 is owned, used, or managed by a user, and may be, for example, a mobile phone, a personal computer, a smart phone, a tablet terminal, or the like. The terminal 2 includes an arithmetic processor and a memory therein, and is provided with a display screen. The terminal 2 may include an input device, such as a keyboard. The keyboard may be a software keyboard. The terminal 2 is connected to the Internet W directly or indirectly, and is capable of communicating with the content server 4 via the Internet W.

With the use of, for example, an application program such as an Internet browser, the terminal 2 receives a certain web page from the content server 4 via the Internet W, and the certain web page is displayed on the display screen.

Content Server 4

The content server 4 provides web content information (hereinafter simply referred to as content information) to a user. Examples of the content information include news information, blog information, and Internet shop information. The content server 4 is capable of transmitting information to and receiving information from the terminal 2 in a wired or wireless manner, and is capable of transmitting content information to the terminal 2. Although not illustrated, a plurality of content servers 4 may be connected. For example, a content server 4 that stores content information about a link source web page 5 and a content server 4 that stores content information about a link destination web page 7 may be different from each other.

When at least content information about the link destination web page 7 is displayed on the display screen of the terminal 2, an advertisement frame is placed at a portion of the page layout of the content information. Advertisement information (distributed information) to be posted in the advertisement frame is distributed from an advertisement distribution apparatus (not illustrated).

Advertiser Server 8

The advertiser server 8 has a function of providing detailed information about an item or the like to the terminal 2 in response to a request from the terminal 2. The advertiser server 8 has a site page in which an advertiser site is constructed. Detailed information about an item or the like is posted on the site page.

If advertisement information displayed on the terminal 2 is an advertisement such as a banner advertisement, and if the advertisement is embedded with link information linking to the advertiser server 8, a request signal is transmitted from the terminal 2 to the advertiser server 8 upon click (selection) of the advertisement on the terminal 2. In response to the request signal, the advertiser server 8 transmits information about a site page containing detailed information abut an item or the like to the terminal 2. Accordingly, the site page of the advertiser server 8 is displayed on the display screen of the terminal 2, and the detailed information about an item or the like is provided to the user of the terminal 2.

A manager of the content server 4 (medium provider) may be a manager of the advertiser server 8. In a case where the content server 4 for the link source web page 5 is different from the content server 4 for the link destination web page 7, the manager of the content server 4 for the link source web page 5 and/or the manager of the content server 4 for the link destination web page 7 may be a manager of the advertiser server 8. Alternatively, the manager of the content server 4 (medium provider) does not have to be the manager of the advertiser server 8.

Profit Index Value generation Apparatus 6

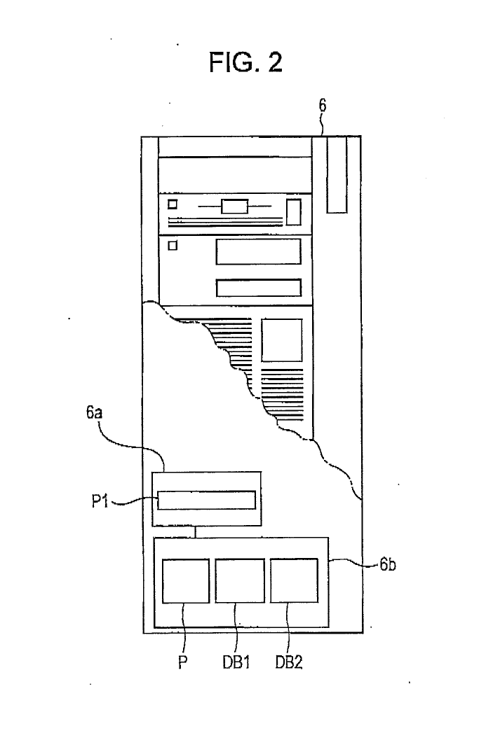

FIG. 2 is a block diagram illustrating a schematic inner configuration of the profit index value generation apparatus 6. The profit index value generation apparatus 6 includes a central processing unit (CPU, an arithmetic processor) 6a and a memory 6b therein, which serve as a main part of a computer. The memory 6b stores a profit index value generation program P, a first database DB1, and a second database DB2.

In accordance with the profit index value generation program P, the CPU 6a functions as a profit index value calculating unit P1. Hereinafter, a description will, be given of the function that is implemented by the CPU 6a in accordance with the profit index value generation program P.

Profit Index Value Calculating Unit P1

The profit index value calculating unit P1 has a function of calculating a profit index value F related to a link destination web page in accordance with a selection probability value C and an expected profit value R.

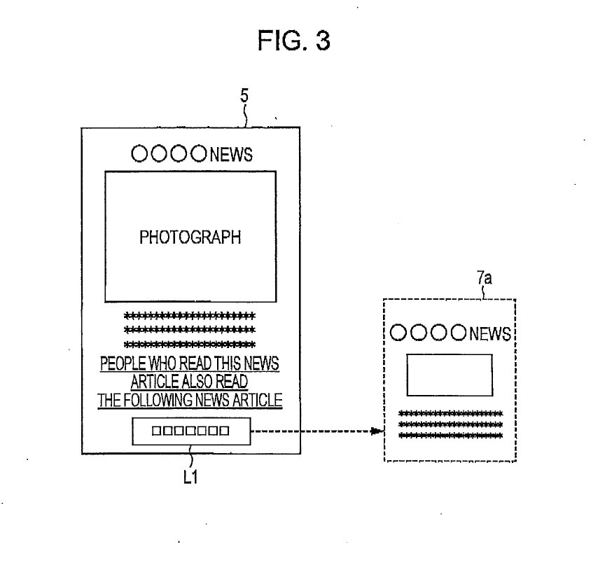

FIG. 3 illustrates an example of the link source web page 5 displayed on the display screen of the terminal 2.

The link source web page 5 shows a news article. Also, the link source web page 5 contains link information L1 (recommendation information) linking to a web page (link destination web page 7a) containing another news article. The link information L1 is below a message “people who read this news article also read the following news article”. For example, in a case where a reader of the link source web page 5 is interested in the other news article, the link information L1 is selected by the reader. Although not illustrated, an item may be introduced on the link source web page 5, and the link source web page 5 may contain link information L (recommendation information) linking to the link destination web page 7 that introduces a related item.

The probability in which the link information L1 linking to the link destination web page 7a is selected by a reader of the link source web page 5 may be calculated in accordance with the relevance between the news article on the link source web page 5 and the news article on the link destination web page 7a, past statistical information that is obtained by compiling and analyzing a history of transition from the link source web page 5 to each link destination web page 7, and so forth.

The probability in which the link information L1 linking to the link destination web page 7a is selected by a reader of the link source web page 5 is indicated as a selection probability value C.

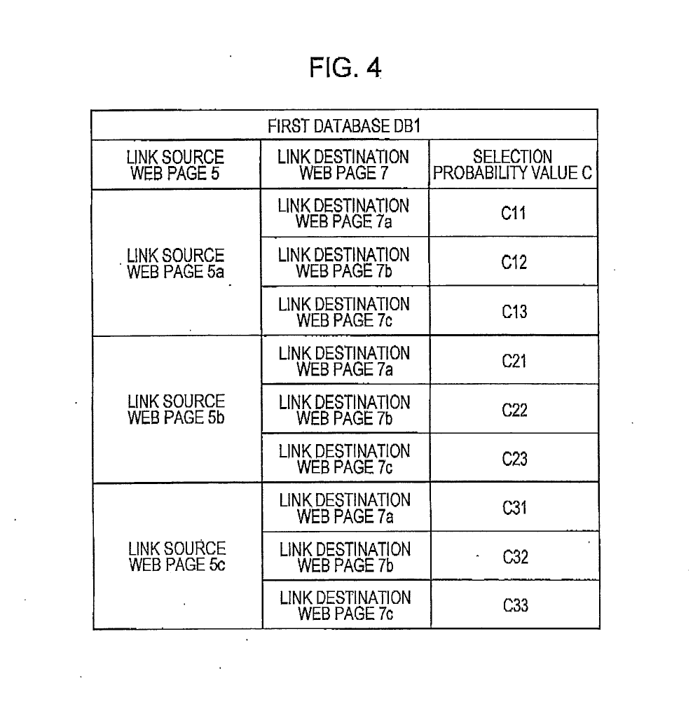

FIG. 4 is a diagram illustrating a schematic data structure of the first database DB1. The first database DB1 is constructed such that a link destination web page 7 and a selection probability value C are associated with each other for each link source web page 5. For example, the selection probability value in a case where the link information L1 linking to the link destination web page 7a is posted on a link source web page 5a is C11. The selection probability value in a case where the link information L1 linking to the link destination web page 7a is posted on a link source web page 5b is C21.

In a case where the reader of the link source web page 5 illustrated in FIG. 3 selects the link information L1, the link destination web page 7a is displayed on the display screen of the terminal 2.

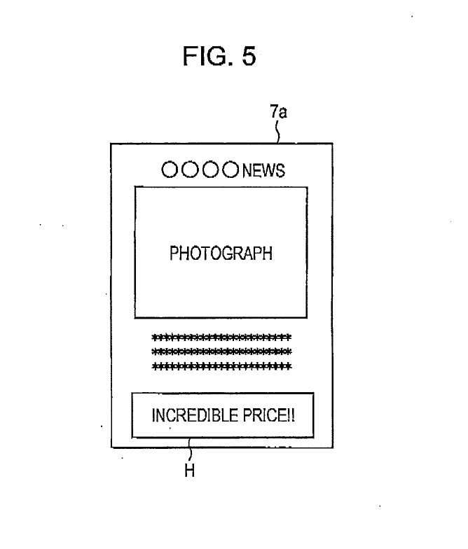

FIG. 5 illustrates an example of the link destination web page 7a displayed on the display screen of the terminal 2. The link destination web page 7a contains advertisement information H in addition to a news article. For example, the advertisement information H is distributed to the terminal 2 from the profit index value generation apparatus 6, which may also function as a server. A profit is generated as a result of the advertisement information H being displayed. The system in which a profit is generated as a result of the advertisement information H being displayed is not particularly limited. For example, a profit may be generated in accordance with the number of times the advertisement information H is displayed together with the link destination web page 7a (impression guaranteed advertisement), or a profit may be generated in accordance with the number of times the advertisement information H posted on the link destination web page 7a is selected (pay per click advertising). Alternatively, a profit may be generated in accordance with the length of a time period over which the advertisement information H is displayed together with the link destination web page 7a (pay per unit time advertising).

An expected profit value R indicates the amount of profit that may be expected to be generated as a result of the advertisement information H being displayed on the display screen of the terminal 2 together with the link destination web page 7a. For example, the expected profit value R may be calculated as the amount of profit that is expected to be generated as a result of the advertisement information H being displayed once together with the link destination web page 7a, in accordance with past statistical information.

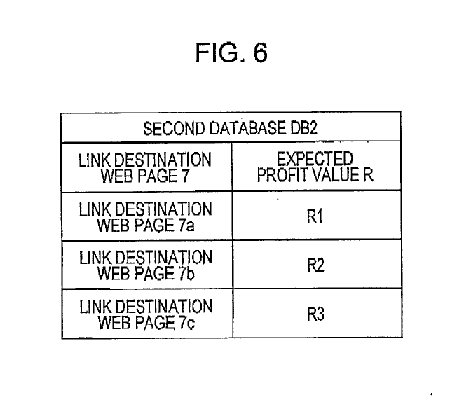

FIG. 6 is a diagram illustrating a schematic data structure of the second database DB2. The second database DB2 is constructed such that a link destination web page 7 and an expected profit value R are associated with each other. For example, the expected profit value for the link destination web page 7a is R1. The expected profit value for the link destination web page 7b is R2.

The profit index value calculating unit P1 retrieves data of a selection probability value C stored in the first database DB1 and data of an expected profit value R stored in the second database DB2, and calculates a profit index value F.

The first database DB1 and the second database DB2 may be stored in a database server (not illustrated) that is connected via the Internet W, instead of being stored in the memory 6b of the profit index value generation apparatus 6. In this case, data of a selection probability value C and an expected profit value R is transmitted to the profit index value generation apparatus 6 via the Internet W.

A profit index value F is calculated in accordance with a selection probability value C and an expected profit value R. To calculate a profit index value F, an equation that has been devised on the basis of past statistical information or various analysis methods and that is for deriving a profit index value F from a selection probability value C and an expected profit value R may be applied.

As the above-described equation, an equation for calculating a profit index value F by multiplying a selection probability value C by an expected profit value R may be applied.

For example, to calculate a profit index value F in a case where the link information L1 linking to the link destination web page 7a is posted on the link source web page 5a, C11, which is the selection probability value in a case where the link information L1 linking to the link destination web page 7a is posted on the link source web page 5a, is retrieved from the first database DB1. Further, R1, which is the expected profit value for the link destination web page 7a, is retrieved from the second database DB2. To calculate the profit index value F by multiplying the selection probability value C by the expected profit value R, C11 is multiplied by R1 (C11×R1) to calculate the profit index value F.

As described above, as a result of calculating the profit index value F, the amount of profit that will be obtained from the advertisement information H displayed on the display screen of the terminal 2 together with the link destination web page 7a as a result of the link information L1 being selected may be known in a case where the link information L1 linking to the link destination web page 7a is posted on the link source web page 5a.

### Second Embodiment

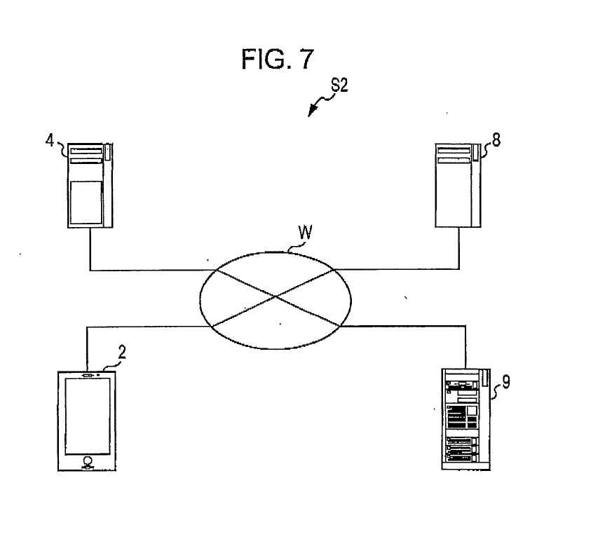

Hereinafter, a second embodiment will be described with reference to the drawings. In the second embodiment, the same parts as those in the first embodiment are denoted by the same reference numerals, and the description thereof is omitted. FIG. 7 is a diagram illustrating an overall configuration of a profit index value generation system S2 according to the second embodiment. The profit index value generation system S2 includes the terminal 2, the content server 4, a profit index value generation apparatus 9, and the advertiser server 8, which are connected to one another so as to be capable of transmitting and receiving information via the Internet W.

In the second embodiment, the configurations and functions of the terminal 2, the content server 4, and the advertiser server 8 are almost the same as those described above in the first embodiment, and thus the detailed description thereof is omitted here.

Profit Index Value Generation Apparatus 9

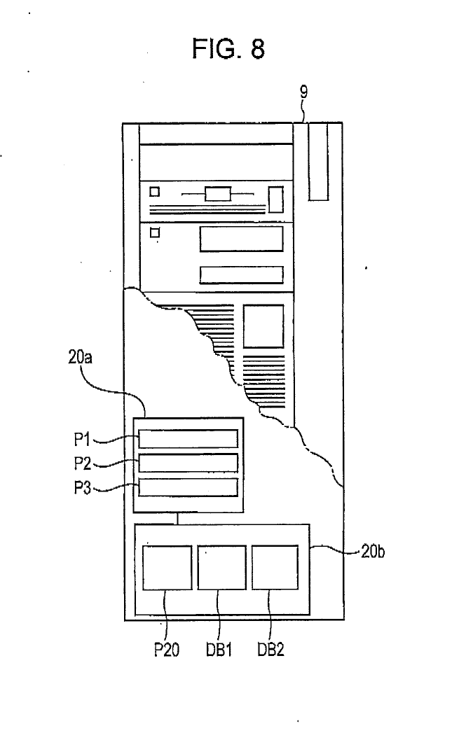

FIG. 8 is a block diagram illustrating a schematic inner configuration of the profit index value generation apparatus 9. The profit index value generation apparatus 9 includes a CPU (an arithmetic processor) 20a and a memory 20b therein, which serve as a main part of a computer. The memory 20b stores a profit index value generation program P20, the first database DB1, and the second database DB2.

In accordance with the profit index value generation program P20, the CPU 20a functions as the profit index value calculating unit P1, a ranking unit P2, and a link information posting unit P3.

Hereinafter, a description will be given of individual functions implemented by the CPU 20a in accordance with, the profit index value generation program P20. In the second embodiment, the configuration and function of the profit index value calculating unit P1 are almost the same as those described above in the first embodiment, and thus the detailed description thereof is omitted here.

Ranking Unit P2

The ranking unit P2 has a function of, in a case where a link destination web page 7 includes a plurality of link destination web pages 7, generating rank information that indicates a higher rank by associating the rank information with a link destination web page 7 having a larger profit index value F.

Here, a description will be given of an example in which a profit index value F is calculated by multiplying a selection probability value C by an expected profit value R. In a case where there are a plurality of link destination web pages 7a to 7c for the link source web page 5a, the profit index value calculating unit P2 calculates F11 (=C11×R1), which is a profit index value related to transition from the link source web page 5a to the link destination web page 7a, F12 (=C12×R2), which is a profit index value related to transition from the link source Web page 5a to the link destination web page 7b, and F13 (=C13×R3), which is a profit index value related to transition from the link source web page 5a to the link destination web page 7c.

Here, in a case where F12>F11>F13 is satisfied, the ranking unit P2 generates the following rank information: first ranking for the link destination web page 7b, second ranking for the link destination web page 7a, and third ranking for the link destination web page 7c.

For example, even in a case where C12 (=0.1)<C13 (=0.4) is satisfied for a selection probability value C, if R2 (=1000 yen)>R3 (=200 yen) is satisfied for an expected profit value R, F12 (=100 yen)>F13 (=80 yen) may be satisfied for a profit index value F. In this case, if link information L3 linking to the link destination web page 7c is posted on the link source web page 5a, the link information L3 is selected with higher frequency, but the amount of profit generated as a result of the advertisement information H being displayed together with the link destination web page 7c is smaller. If link information L2 linking to the link destination web page 7b is posted on the link source web page 5a, the link information 12 is selected with lower frequency, but the amount of profit generated as a result of the advertisement information H being displayed together with the link destination web page 7b is larger.

As described above, according to the ranking unit P2, link information L linking to a link destination web page 7 for which a larger amount of profit from the advertisement information H is expected may be grasped.

Link Information Posting Unit P3

The link information posting unit P3 has a function of posting pieces of link information L linking to a plurality of link destination web pages 7 on a link source web page on the basis of rank information.

As described above, in a case where rank information “first ranking” is generated for the link destination web page 7b, rank information “second ranking” is generated for the link destination web page 7a, and rank information “third ranking” is generated for the link destination web page 7c, if a setting is made to maximize profit efficiency, the link information posting unit P3 determines the priority ranking for the link information L2 linking to the link destination web page 7b, the link information L1 linking to the link destination web page 7a, and the link information L3 linking to the link destination web page 7c in this order, and posts the pieces of link information L on the link source web page 5a in accordance with the priority ranking.

For example, in a case where two pieces of link information L may be posted on the link source web page 5a, the link information positing unit P3 posts the link information L2 and the link information L1 on the link source web page 5a.

The link information posting unit P3 may have a function of, in a case where individual pieces of link information L have different selection frequencies depending on the positions where the pieces of link information L are posted on a link source web page, posting a piece of link information L linking to the link destination web page having a higher ranking at the position of higher selection frequency on the link source web page.

As described above, the link information posting unit P3 enables link information L linking to a link destination web page 7 for which a larger amount of profit from the advertisement information H is expected to be posted on a link source web page 5.

### Third Embodiment

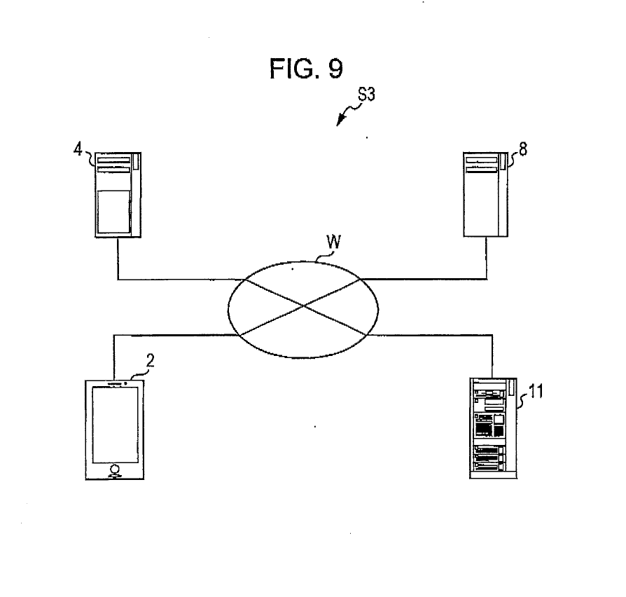

Hereinafter, a third embodiment will be described with reference to the attached drawings. In the third embodiment, the same parts as those in the first embodiment are denoted by the same reference numerals, and the description thereof is omitted. FIG. 9 is a diagram illustrating an overall configuration of a profit index value generation system S3 according to the third embodiment. The profit index value generation system S3 includes the terminal 2, the content server 4, a profit index value generation apparatus 11, and the advertiser server 8, which are connected to one another so as to be capable of transmitting and receiving information via the Internet W.

In the third embodiment, the configurations and functions of the terminal 2, the content server 4, and the advertiser server 8 are almost the same as those described above in the first embodiment, and thus the detailed description thereof is omitted here.

Profit Index Value Generation Apparatus 11

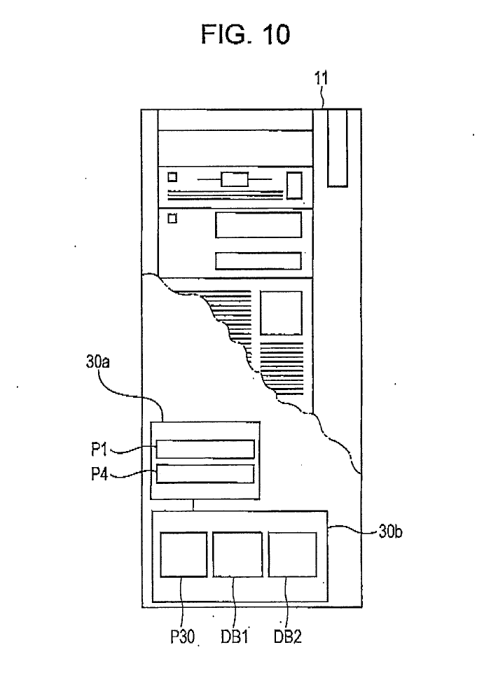

FIG. 10 is a block diagram illustrating a schematic inner configuration of the profit index value generation apparatus 11. The profit index value generation apparatus 11 includes a CPU (an arithmetic processor) 30a and a memory 30b therein, which serve as a main part of a computer. The memory 30b stores a profit index value generation program P30, the first database DB1, and the second database DB2.

In accordance with the profit index value generation program P30, the CPU 30a functions as the profit index value calculating unit P1 and a selection probability value calculating unit P4. In the third embodiment, the configuration and function of the profit index value calculating unit P1 are almost the same as those described above in the first embodiment, and thus the detailed description thereof is omitted here. In the third embodiment, the CPU 30a may function as the ranking unit P2 and the link information posting unit P3, like the CPU 20a according to the second embodiment.

Selection Probability Value Calculating Unit P4

The selection probability value calculating unit P4 has a function of calculating a selection probability value C.

The selection probability value calculating unit P4 may have a function of calculating a selection probability value C in accordance with attribute information related to a link source web page 5 and attribute information related to a link destination web page 7.

Attribute information related to a web page is information that is classified on the basis of the content of the web page, such as an article or photograph. For example, a rule may be applied in which attribute information “car” is assigned to a web page on which a photograph of a car is posted.

In the case of calculating a selection probability value C in accordance with attribute information related to a link source web page 5 and attribute information related to a link destination web page 7, the selection probability value C may be calculated in accordance with the similarity or relevance between the attribute information related to the link source web page 5 and the attribute information related to the link destination web page 7. For example, the attribute information “car” has a high degree of similarity with “bicycle”, which is transportation like a car, and has a high degree of relevance with “tire”, which is a component of a car. The attribute information “car” has a low degree of similarity and relevance with “telephone” and “personal computer”, which are not transportation and are not normally categorized as components of a car. Thus, in a case where the attribute information related to the link source web page 5 represents “car”, the selection probability value C is large if the attribute information related to the link destination web page 7 represents “bicycle” or “tire”, whereas the selection probability value C is small if the attribute information related to the link destination web page 7 represents “telephone” or “personal computer”.

The selection probability value calculating unit P4 may have a function of calculating a selection probability value C in accordance with attribute information related to a reader of the link source web page 5 and attribute information related to the link destination web page 7.

Attribute information related to a reader is information that is classified on the basis of sex or residence of the reader, attribute information about a web page that has been read by the reader, and so forth. For example, a rule may be applied in which, in a case where the reader of the link source web page 5 is female, attribute information “female” is assigned as attribute information related to the reader of the link source web page 5.

In the case of calculating a selection probability value C in accordance with attribute information related to a reader of the link source web page 5 and attribute information related to the link destination web page 7, the selection probability value C may be calculated in accordance with the similarity or relevance between the attribute information related to the reader of the link source web page 5 and the attribute information related to the link destination web page 7. For example, the attribute information “female” has a high degree of relevance with “cosmetics” and “high heels”, which are normally used by women, and has a low degree of relevance with “motorcycle”, which is a vehicle normally liked by men. Thus, in a case where the attribute information related to the reader of the link source web page 5 represents “female”, the selection probability value C is large if the attribute information related to the link destination web page 7 represents “cosmetics” or “high heels”, whereas the selection probability value C is small if the attribute information related to the link destination web page 7 represents “motorcycle”.

The selection probability value calculating unit P4 may have a function of calculating a selection probability value C in accordance with past statistical information indicating that link information L linking to the link destination web page 7 posted on the link source web page 5 has been selected. In a case where there is statistical information indicating that link information L1 linking to the link destination web page 7a is selected with high frequency when the link information L1 is posted on the link source web page 5a, the selection probability value C of the link information L1 linking to the link destination web page 7a is large regarding the link source web page 5a.

Also, the selection probability value calculating unit P4 may have a function of calculating a selection probability value C by using a prediction model. The prediction model is, for example, generated through machine learning that is performed on the basis of statistical information indicating whether or not the link information L linking to a specific link destination web page 7 was selected in a specific time slot for a specific user.

The selection probability value C calculated by the selection probability value calculating unit P4 may be stored in the first database DB1.

The expected profit value R1 for the link destination web page 7a may be calculated by performing the following calculation about a plurality of pieces of advertisement information H that may be posted on the link destination web page 7a. First, a probability of being displayed on the link destination web page 7a (advertisement display probability) is obtained for each piece of advertisement information H. Subsequently, a probability of being selected when posted on the link destination web page 7a (advertisement selection probability) is obtained for each piece of advertisement information H. Further, for each piece of advertisement information H, a charge that is generated when the piece of advertisement information H is selected once (advertisement charge) is obtained. Subsequently, for each piece of advertisement information H, the product of the advertisement display probability, the advertisement selection probability, and the advertisement charge is calculated to calculate an expected amount of profit for each piece of advertisement information H. As a result of summing up the expected amounts of profit for the individual pieces of advertisement information H, the expected profit value R1 may be calculated.

The embodiments of the present invention have been described above. The present invention is not limited to the above-described embodiments, and various modifications and changes can be made without deviating from the gist of the embodiments of the present invention.

An embodiment of the present invention includes the following configuration.

A profit index value generation system includes a profit index value calculating unit configured to calculate a profit index value related to a link destination web page in accordance with (i) a selection probability value that indicates a probability of selection of link information, the link information being posted on a link source web page displayed on a display screen of a terminal and being linked to the link destination web page on which advertisement information is posted, and (ii) an expected profit value that indicates an amount of profit which is expected to be generated as a result of the advertisement information being displayed on the display screen together with the link destination web page.

The profit index value calculating unit may calculate the profit index value by multiplying the selection probability value by the expected profit value.

The profit index value generation system may further include a ranking unit configured to generate, in a case where the link destination web page includes a plurality of link destination web pages, rank information that indicates a higher rank by associating the rank information with a link destination web page having a larger profit index value among the plurality of link destination web pages; and a link information posting unit configured to post pieces of link information linking to the plurality of link destination web pages on the link source web page in accordance with the rank information.

The profit index value generation system may further include a selection probability value calculating unit configured to calculate the selection probability value.

The selection probability value calculating unit may calculate the selection probability value in accordance with attribute information related to the link source web page and attribute information related to the link destination web page.

The selection probability value calculating unit may calculate the selection probability value in accordance with attribute information related to a reader of the link source web page and attribute information related to the link destination web page.

The selection probability value calculating unit may calculate the selection probability value in accordance with past statistical information indicating that link information linking to the link destination web page that is posted on the link source web page has been selected.

An embodiment of the present invention is applicable to a profit index value generation system and a profit index value generation method that are configured to generate an index for appropriately selecting a link destination web page linked from a link source web page via link information.

What is claimed is:

1. A profit index value generation system comprising:
a profit index value calculating unit configured to calculate a profit index value related to a link destination web page in accordance with
(i) a selection probability value that indicates a probability of selection of link information, the link information being posted on a link source web page displayed on a display screen of a terminal and being linked to the link destination web page on which advertisement information is posted, and
(ii) an expected profit value that indicates an amount of profit which is expected to be generated as a result of the advertisement information being displayed on the display screen together with the link destination web page.

2. The profit index value generation system according to claim 1, wherein the profit index value calculating unit calculates the profit index value by multiplying the selection probability value by the expected profit value.

3. The profit index value generation system according to claim 1, further comprising:
a ranking unit configured to generate, in a case where the link destination web page includes a plurality of link destination web pages, rank information that indicates a higher rank by associating the rank information with a link destination web page having a larger profit index value among the plurality of link destination web pages; and
a link information posting unit configured to post pieces of link information linking to the plurality of link destination web pages on the link source web page in accordance with the rank information.

4. The profit index value generation system according to claim 1, further comprising:
a selection probability value calculating unit configured to calculate the selection probability value.

5. The profit index value generation system according to claim 4, wherein the selection probability value calculating unit calculates the selection probability value in accordance with attribute information related to the link source web page and attribute information related to the link destination web page.

6. The profit index value generation system according to claim 4, wherein the selection probability value calculating unit calculates the selection probability value in accordance with attribute information related to a reader of the link source web page and attribute information related to the link destination web page.

7. The profit index value generation system according to claim 4, wherein the selection probability value calculating unit calculates the selection probability value in accordance with past statistical information indicating that link information linking to the link destination web page that is posted on the link source web page has been selected.

8. A profit index value generation method comprising:
calculating a profit index value related to a link destination web page in accordance with
(i) a selection probability value that indicates a probability of selection of link information, the link information being posted on a link source web page displayed on a display screen of a terminal and being linked to the link destination web page on which advertisement information is posted, and
(ii) an expected profit value that indicates an amount of profit which is expected to be generated as a result of the advertisement information being displayed on the display screen together with the link destination web page.
